(19) United States
(12) Patent Application Publication
(10) Pub. No.: US 2017/0214937 A1
(43) Pub. Date: Jul. 27, 2017

(54) Apparatus of Inter Prediction for Spherical Images and Cubic Images

(71) Applicant: MEDIATEK INC., Hsin-Chu (TW)

(72) Inventors: Hung-Chih LIN, Caotun Township (TW); Shen-Kai CHANG, Zhubei City (TW)

(21) Appl. No.: 15/399,813

(22) Filed: Jan. 6, 2017

Related U.S. Application Data
(60) Provisional application No. 62/281,815, filed on Jan. 22, 2016.

(51) Int. Cl. H04N 19/577; H04N 19/56; H04N 19/563

(52) U.S. Cl. CPC H04N 19/577; H04N 19/563; H04N 19/56

(57) ABSTRACT

Methods and apparatus of video encoding and decoding for a spherical image sequence and a cubic image sequence using circular Inter prediction are disclosed. For the spherical image sequence, the search window includes an area outside or crossing a vertical frame boundary of the reference frame for at least one block of the current spherical image to be encoded. Candidate reference blocks within the search window are determined, where if a given candidate reference block is outside or crossing one vertical frame boundary, the reference pixels are accessed circularly from the reference frame in a horizontal direction crossing the vertical frame boundary of the reference frame. For the cubic image sequence, circular edges of the cubic frame are determined. The search window includes an area outside or crossing a circular edge of the reference frame for at least one block of the current cubic frame to be encoded.

### CROSS REFERENCE TO RELATED APPLICATIONS

The present invention claims priority to U.S. Provisional Patent Application, Ser. No. 62/281,815, filed on Jan. 22, 2016. The U.S. Provisional Patent Application is hereby incorporated by reference in its entirety.

### FIELD OF THE INVENTION

The present invention relates to image and video coding. In particular, the present invention relates to techniques of Inter prediction for spherical images and cubic frames converted from the spherical images.

### BACKGROUND AND RELATED ART

The 360-degree video, also known as immersive video is an emerging technology, which can provide “feeling as sensation of present”. The sense of immersion is achieved by surrounding a user with wrap-around scene covering a panoramic view, in particular, 360-degree field of view. The “feeling as sensation of present” can be further improved by stereographic rendering. Accordingly, the panoramic video is being widely used in Virtual Reality (VR) applications.

Immersive video involves the capturing a scene using multiple cameras to cover a panoramic view, such as 360-degree field of view. The immersive camera usually uses a set of cameras, arranged to capture 360-degree field of view. Typically, two or more cameras are used for the immersive camera. All videos must be taken simultaneously and separate fragments (also called separate perspectives) of the scene are recorded. Furthermore, the set of cameras are often arranged to capture views horizontally, while other arrangements of the cameras are possible.

FIG. 1 illustrates an exemplary processing chain for 360-degree spherical panoramic images. The 360-degree spherical panoramic images may be captured using a 360-degree spherical panoramic camera. Spherical image processing unit 110 accepts the raw image data from the camera to form 360-degree spherical panoramic images. The spherical image processing may include image stitching and camera calibration. The spherical image processing is known in the field and the details are omitted in this disclosure. The conversion can be performed by a projection conversion unit 120 to derive the six-face images corresponding to the six faces of a cube. Since the 360-degree image sequences may require large storage space or require high bandwidth for transmission, video encoding by a video encoder 130 may be applied to the video sequence to reduce required storage or transmission bandwidth. The system shown in FIG. 1 may represent a video compression system for spherical image sequence (i.e., Switch at position A). The system shown in FIG. 1 may also represent a video compression system for cubic image sequence (i.e., Switch at position B). At a receiver side or display side, the compressed video data is decoded using a video decoder 140 to recover the sequence of spherical image or cubic image for display on a display device 150 (e.g. a VR (virtual reality) display).

Since the data related to 360-degree spherical images and cubic images usually are much larger than conventional two-dimensional video, video compression is desirable to reduce the required storage or transmission. Accordingly, in a conventional system, regular video encoding 130 and regular decoding 140 such as H.264 or the newer HEVC (High Efficiency Video Coding) may be used. The conventional video coding treats the spherical images and the cubic images as frames captured by a conventional video camera disregarding the unique characteristics of the underlying the spherical images and the cubic images as frames.

In conventional video coding systems, the processes of motion estimation (ME) and motion compensation (MC) perfroms the replication padding that repeats the frame boundary pixels when the selected reference block is outside or crossing frame boundary of the reference frame. Unlike the conventional 2D video, a 360-degree video is an image sequence representing the whole environment around the captured cameras. Although the two commonly used projection formats, sphereical and cubic formats, can be arranged into a rectangular frame, geometically there is no boundary in a 360-degree frame.

In the present invention, new Inter prediction techniques are disclosed to improve the coding performance.

### BRIEF SUMMARY OF THE INVENTION

Apparatus of video encoding for a spherical image sequence are disclosed. A search window in a reference frame is determined for a current block in a current spherical frame, where the search window includes an area outside or crossing a vertical frame boundary of the reference frame for at least one block of the current spherical frame to be encoded. One or more candidate reference blocks within the search window are determined. If a given candidate reference block is outside or crossing one vertical frame boundary of the reference frame horizontally, reference pixels of the given candidate reference block outside or crossing the vertical frame boundary of the reference frame are accessed circularly from the reference frame in a horizontal direction crossing the vertical frame boundary of the reference frame. A final reference block is then selected among the candidate reference blocks based on a performance criterion associated with the candidate reference blocks. Inter prediction is applied to the current block using the final reference block as an Inter predictor to generate prediction residuals. The prediction residuals are encoded into a video bitstream and the video bitstream is outputted.

Method and apparatus of video decoding for a spherical image sequence are also disclosed. A motion vector is derived from the video bitstream for a current block if this block is inter-coded. Then, a reference block in a reference frame is determined according to the motion vector for reconstruction. If the reference block is outside or crossing one vertical frame boundary of the reference frame, the reference pixels of the reference block outside or crossing said one vertical frame boundary of the reference frame are accessed circularly from the reference frame in a horizontal direction crossing said one vertical frame boundary of the reference frame. The decoded prediction residuals are decompressed from the video bitstream for the current block. The current block is finally reconstructed from the decoded prediction residuals using the reference block of the reference frame as an Inter predictor. The spherical image sequence comprising the reconstructed current block is outputted.

In the above encoding and decoding methods for the spherical image sequence, if the given candidate reference block is outside or crossing one horizontal frame boundary of the reference frame, the reference pixels of the given candidate reference block outside the horizontal frame boundary of the reference frame are padded according to a padding process. The circular access of the reference frame can be implemented using a modulo operation on horizontal-axis (for example, x-axis) of the reference pixels of the given candidate reference block to reduce the memory footprint of the reference frame.

Method and apparatus of video encoding for a cubic image sequence are disclosed. Each cubic frame is generated by unfolding six cubic faces from a cube and the six cubic faces are generated by projecting a spherical image corresponding to a 360-degree panoramic picture onto the cube. Circular edges of the cubic frame for any non-connected or discontinuous cubic-face image edge are identified, wherein each circular edge of the cubic frame is associated with two neighboring cubic faces joined by one circular edge on the cube. A search window in a reference frame for a current block in a current cubic frame is determined, where the search window includes an area outside or crossing a circular edge of the reference frame for at least one block of the current cubic frame to be encoded. One or more candidate reference blocks within the search window are determined. If a given candidate reference block is outside or crossing one circular edge of the reference frame with respect to a co-located block of the current block, reference pixels of the given candidate reference block outside or crossing said one circular edge of the reference frame are accessed circularly from the reference frame across said one circular edge of the reference frame. A final reference block among said one or more candidate reference blocks is selected based on a performance criterion associated with said one or more candidate reference blocks. Inter prediction is then applied to the current block using the final reference block as an Inter predictor to generate prediction residuals. The prediction residuals are encoded into a video bitstream and the video bitstream is outputted.

Method and apparatus of video decoding for a cubic image sequence are also disclosed. A video bitstream associated with a cubic image sequence is received. Circular edges of the cubic frame for any non-connected or discontinuous cubic-face image edge are determined. A motion vector is derived from the video bitstream for a current block if this block is Inter-coded. Then, a reference block in a reference frame is determined according to the motion vector. If the reference block is outside or crossing one circular edge of the reference frame with respect to a collocated block of the current block, the reference pixels of the reference block outside or crossing said one circular edge of the reference frame are accessed circularly from the reference frame across said one circular edge of the reference frame. The decoded prediction residuals are decompressed from the video bitstream for the current block. The current block is finally reconstructed from the decoded prediction residuals and the reference block of the reference frame. The cubic image sequence comprising reconstructed current block is outputted.

In the above encoding and decoding methods for the cubic image sequence, each cubic frame may correspond to one cubic net with blank areas filled with padding data to form a rectangular frame according to one embodiment and each cubic frame may correspond to one assembled frame without any padding area according to another embodiment. If the given candidate reference block is outside or crossing one circular edge of the reference frame with respect to a co-located block of the current block, the reference pixels of the given candidate reference block outside or crossing said one circular edge of the reference frame are accessed circularly from the reference frame by applying a circular operation on horizontal-axis (for example, x-axis) and vertical-axis (for example, y-axis) of the reference pixels of the given candidate reference block, and where the circular operation takes into account of continuity across the circular edges. The circular operation causes the reference pixels of a given candidate reference block outside or crossing said one circular edge of the reference frame rotated by a rotation angle determined according to an angle between said one circular edge of the reference frame and a corresponding circular edge. The rotation angle includes 0, 90, 180 and 270 degrees.

### BRIEF DESCRIPTION OF THE DRAWINGS

FIG. 1 illustrates an exemplary processing chain for 360-degree spherical panoramic frames.

FIG. 2A illustrates examples of numbering of the cubic faces, where the cube has six faces, three faces are visible and the other three faces are invisible since they are on the back side of the cube.

FIG. 2B illustrates an example corresponding to an unfolded cubic image generated by unfolding the six faces of the cube, where the numbers refer to their respective locations and orientations on the cube.

FIG. 2C illustrates an example corresponding to an assembled cubic-face image without blank areas.

FIG. 3 illustrates an exemplary implementation of the circular Inter prediction for spherical image sequence or cubic image sequence, where the conventional video encoder and conventional video decoder in FIG. 1 are replaced by video encoder and video decoder with circular Inter prediction according to embodiments of the present invention.

FIG. 4 illustrates an example of a reference block outside the reference frame, where the dashed-line block corresponds to a co-located block for a current block being coded.

FIG. 5A illustrates a block diagram for circular Inter prediction at the video encoder side, where a simplified model for circular Inter prediction is shown and only the process directly related to circular Inter prediction is included.

FIG. 5B illustrates a block diagram for circular Inter prediction at the video decoder side, where a simplified model for circular Inter prediction is shown and only the process directly related to circular Inter prediction is included.

FIG. 6 illustrates an example of circular Inter prediction for a current spherical frame, where blocks A and B are two blocks in the current frame to be coded.

FIG. 7 illustrates an example of three candidate reference blocks (labelled as X, Y and Z in FIG. 7) for the block A in the current frame according to circular Inter prediction.

FIG. 8 illustrates another example of reference blocks that are partially outside the top frame boundary or bottom frame boundary.

FIG. 9 illustrates the 11 distinct cubic nets for unfolding the six cubic faces, where cube face number 1 is indicated in each cubic net.

FIG. 10 illustrates examples of the circular edge labeling of the six cubic faces for a cubic frame corresponding to a cubic net with blank areas filled with padding data and an assembled 1×6 cubic-face frame.

FIG. 11 illustrates an example of circular Inter prediction for cubic frame corresponding to a cubic net with blank areas filled with padding data, where blocks A and B are two blocks in the current frame to be processed.

FIG. 12 illustrates an example of a reference block X for block A in the current frame, where the reference block X crosses the circular edge #3 of cubic face 2 to flow into the cubic face 3 from its circular edge #3.

FIG. 13 illustrates another example of accessing reference pixels circularly according to circular edge labelling for cubic frame corresponding to a cubic net with filled blank areas.

FIG. 14 illustrates an example of circular Inter prediction for cubic frame corresponding to an assembled cubic frame without blank area, where blocks A and B are two blocks in the current frame to be processed.

FIG. 15 illustrates an example of a reference block X for block A in the current frame, where the reference block X crosses the circular edge #8 of cubic face 5 to flow into the cubic face 1 from its circular edge #8.

FIG. 16 illustrates an exemplary flowchart for a video encoder incorporating an embodiment of the present invention, where circular Inter prediction is applied to a spherical image sequence.

FIG. 17 illustrates an exemplary flowchart for a video decoder incorporating an embodiment of the present invention, where circular Inter prediction is applied to a spherical image sequence.

FIG. 18 illustrates an exemplary flowchart for a video encoder incorporating an embodiment of the present invention, where circular Inter prediction is applied to a cubic image sequence.

FIG. 19 illustrates an exemplary flowchart for a video decoder incorporating an embodiment of the present invention, where circular Inter prediction is applied to a cubic image sequence.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

As mentioned before, the conventional video coding treats the spherical images and the cubic images as regular frames from a regular video camera. When Inter prediction is applied, a reference block in a reference frame is identified and used as a temporal predictor for the current block. Usually, a pre-determined search window in the reference frame is searched to find a best matched block. The search window may cover an area outside the reference frame, especially for a currently close to the frame boundary. When the search area is outside the reference frame, the motion estimation is not performed or pixel data outside the reference frame is generated artificially in order to apply motion estimation. In conventional video coding systems, such as H.264 and HEVC, the pixel data outside the reference frame are generated by repeating boundary pixels.

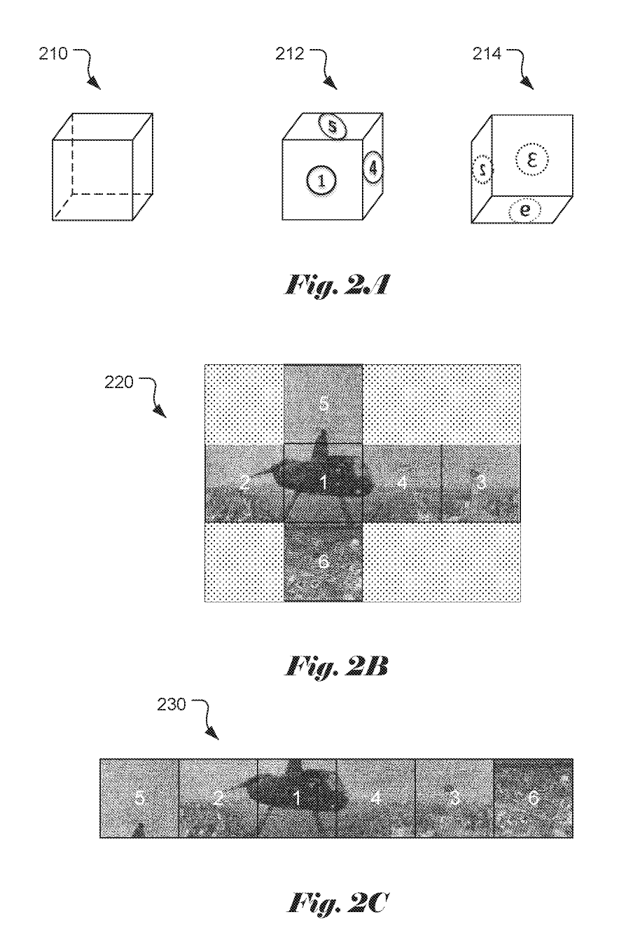

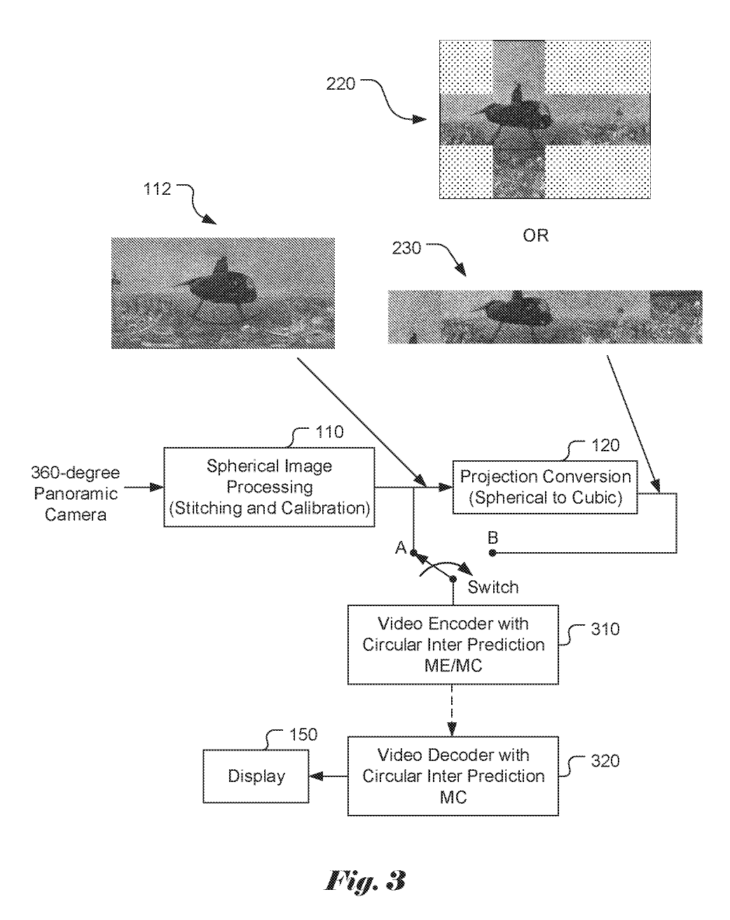

As mention before, since the 360-degree panorama camera captures scenes all around, the stitched spherical image is continuous in the horizontal direction. That is, the contents of the spherical image at the left end continue to the right end. The spherical image can also be projected to the six faces of a cube as an alternative 360-degree format. The conversion can be performed by projection conversion to derive the six-face images representing the six faces of a cube. On the faces of the cube, these six images are connected at the edges of the cube. FIG. 2A to FIG. 2C illustrate examples of cubic-face images. In FIG. 2A, the cube 210 has six faces. The three visible faces, labelled as 1, 4 and 5, are shown in the middle illustration 212, where the orientation of the numbers (i.e., “1”, “4” and “5”) indicates the cubic-face image orientation. There are also three cubic-face images being blocked and invisible from the front side as shown by illustration 214. The three blocked cubic-face images are labelled as 2, 3 and 6, where the orientation of the numbers (i.e., “2”, “3” and “6”) indicates the cubic-face image orientation. These three numbers enclosed in dashed circle for the invisible cubic images indicate the see-through images since they are on the back sides of the cube. Image 220 in FIG. 2B corresponds to an unfolded cubic image with blank areas filled with padding data, where the numbers refer to their respective locations and orientations on the cube. As shown in FIG. 2B, the unfolded cubic-face images are fitted into a smallest rectangular that covers the six unfolded cubic-face images. Image 230 in FIG. 2C corresponds to an assembled rectangular frame without any blank area, where the assembled frame is of 1×6 cubic faces. The picture in FIG. 2B as a whole is referred as a cubic frame in this disclosure. Also, the picture in FIG. 2C as a whole is referred as a cubic frame in this disclosure.

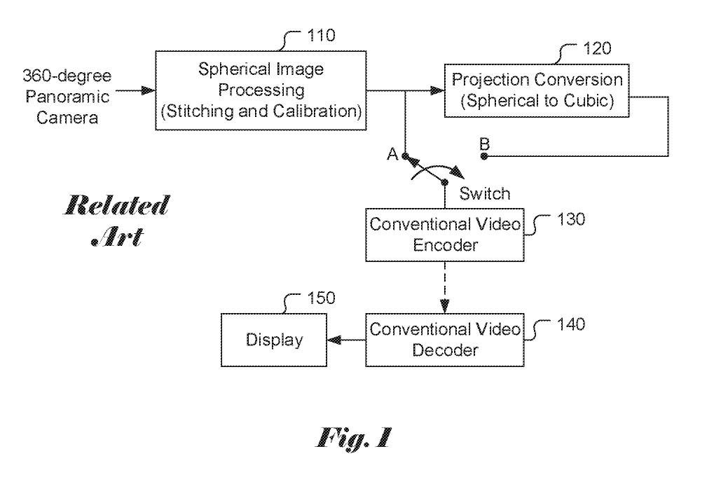

In order to take advantage of the horizontal continuity of the spherical frame and the continuity between some cubic-face images of the cubic frame, the present invention discloses circular Inter prediction to exploit the horizontal continuity of the spherical frame and the continuity between some cubic-face images of the cubic frame. An exemplary implementation of the circular Inter prediction for spherical image sequence or cubic-face image sequence is shown in FIG. 3, where the conventional video encoder 130 and conventional video decoder 140 in FIG. 1 are replaced by video encoder with circular Inter prediction ME/MC 310 and video decoder with circular Inter prediction MC 320 according to embodiments of the present invention. In the video encoder 310, the circular Inter prediction is used for motion estimation (ME) and motion compensation (MC). In the video decoder 320, the circular Inter prediction is used for motion compensation (MC). For convenience, system block diagram in FIG. 3 is intended to illustrate two types of the system structure: one for compression of spherical image system and one for the cubic image sequence. For a system to encode a sequence with a known format (either the spherical image sequence or the cubic image sequence), the Switch does not exist. Furthermore, the cubic frame may correspond to the unfolded cubic-face images with blank areas filled with padding data (220) or the assembled rectangular frame without any blank area (230).

Circular Inter Prediction for Spherical Image Sequence

In Inter prediction, a reference block in a reference frame is found by searching within a pre-determined window that may be around a co-located block in the reference frame (The co-located block is a block in the reference frame located at the same location as a block being processed in the current frame). A reference block within the pre-determined search window may become outside or partially outside the reference frame. FIG. 4 illustrates an example of a reference block (412) outside the reference frame 400. The dashed-line block 410 corresponds to the co-located block of the current block in the reference frame. Line 424 indicates the left boundary of reference frame 400. Block 412 corresponds to a reference block being searched, which is partially outside reference frame 400. Motion vector 414 points from the current block (i.e., co-located block 410) to the reference block 412. In a conventional video coding system, the pixels in the reference block outside the reference frame would be filled with padding data. However, the spherical frame represents a 360-degree field of view with left edge of the frame wrapped around with the right edge of the frame. Therefore, the frame contents beyond the left edge of the frame can be obtained from the right part of the frame. For example, a stripe 422 at the right edge of the reference frame corresponds to the extended left side 422a of the reference frame. Therefore, all the pixel data for reference block 412 become available according to the present invention.

In order to take advantage of the horizontal continuity across the vertical frame boundaries of the spherical frames, circular Inter prediction is disclosed in the present invention. According to circular Inter prediction, the Inter prediction process examines the horizontal component of the motion. If the referenced area is outside the vertical frame boundary or across the vertical frame boundary, the reference pixels are accessed circularly from the other side of the frame boundary into the reference frame. For example, for the pixels beyond the left frame boundary 424 toward the left as indicated by arrow 430 can be accessed from the right side of the frame as indicated by arrow 432. Pixels A and B outside the left frame boundary 424 correspond to pixels A′ and B′ on the right side of the reference frame starting from the right frame boundary 426. This horizontal wrap-around access can be implemented as modulo operation (i.e., modulo of frame width). In other words, the horizontal location x′ pointed by a motion vector mv=(mvₓ, mv_{y}) from a current location (x, y) can be implemented as:

x′=(x+mvₓ) mod V_{w}. (1)

In the above equation, V_{w} is the frame width and “mod” represents the modulo operator.

For spherical frames, the vertical direction is not continuous. Therefore, if any reference pixel is outside the horizontal frame boundary (e.g. above the top frame boundary or below the bottom frame boundary), any known padding method can be used to handle the unavailable pixels. For example, the unavailable reference pixels at the top part or bottom part of the reference frame can be padded. The padding methods may correspond to padding with zero, replicating the boundary values, extending boundary pixels using mirror images of boundary pixel area, or padding with circular repetition of pixels.

After the reference pixels are determined according to the circular Inter prediction method, any known motion estimation algorithm can be used according to a pre-defined cost function. Then, an optimal motion vector is obtained from a candidate reference block within a search window. The motion information is finally encoded in the video bitstream.

With the motion information decoded from the bitstream, the location of the reference block can be located. According to the circular Inter prediction method, the horizontal location of the reference block is identified. If the reference block is outside the vertical frame boundary, the reference pixels beyond the vertical frame boundary can be accessed circularly. For example, modulo operation can be applied to the horizontal location to locate the circularly access reference data. For the reference block outside or crossing the horizontal frame boundary, the reference pixels in the top part or bottom part of the reference frame can be padded using a padding method used by the encoder. The unavailable reference pixels at the top part or bottom part of the reference frame can be padded. The padding methods may correspond to padding with zero, replicating the boundary values, extending boundary pixels using mirror images of boundary pixel area, or padding with circular repetition of pixels. A block can be reconstructed based on the residual block and the prediction block, where information related to the residual block is signaled in the bitstream.

FIG. 5A illustrates a block diagram for circular Inter prediction at the video encoder side, where a simplified model for circular Inter prediction is shown and only the process directly related to circular Inter prediction is included. The spherical image sequence is provided for the circular Inter prediction process. The Search Range Construction Unit 510 is used to prepare search data for circular Inter prediction. In particular, if the reference area is outside or crossing the vertical reference frame boundary, the reference pixels outside the vertical reference frame boundary are accessed circularly in the horizontal direction. For example, modulo operation can be used on the horizontal-axis (for example, x-axis) of the calculated reference pixel location. In the vertical direction, conventional pixel padding can be used to generate the unavailable pixels outside the horizontal frame boundary. The Circular Prediction Block Construction Unit 520 derives one or more candidate reference blocks associated with candidate motion vectors according to circular Inter prediction. If a motion vector points to a candidate reference block outside or crossing the vertical reference frame boundary, the reference pixels from the other side of the vertical reference frame boundary are used by accessing the pixel data circularly in the horizontal direction. If a fractional-pixel motion vector is used, interpolation can be used to derive the reference block according to the fractional-pixel motion vector. Motion vector is selected using Motion Vector Selection Unit 530 according to a performance criterion. For example, rate-distortion optimization (RDO) can be applied to select a best MV.

FIG. 5B illustrates a block diagram for circular Inter prediction at the video decoder side, where a simplified model for circular Inter prediction is shown and only the prediction process directly related to circular Inter prediction is included. The residuals and motion information are provided for the circular Inter prediction process. As is known in the art, the residuals and motion information can be recovered from the video bitstream. For example, the decoder may use entropy decoding, inverse quantization and inverse transform to recover the residuals. The motion information (for example, MVD) can be also decompressed from the video bitstream. The Motion Vector Derivation Unit 540 determines the current MV based on the MV predictor and MVD derived from the video bitstream if the current MV is coded predictively. The Circular Prediction Block Construction Unit 550 derives a reference block associated with the derived motion vector according to circular Inter prediction. Again, if the motion vector points to a reference block outside or crossing the vertical reference frame boundary, the reference pixels from the other side of the vertical frame boundary are used by accessing the pixel data circularly in the horizontal direction. The reference block can be reconstructed using Block Reconstruction Unit 560 based on the residuals and the selected reference block.

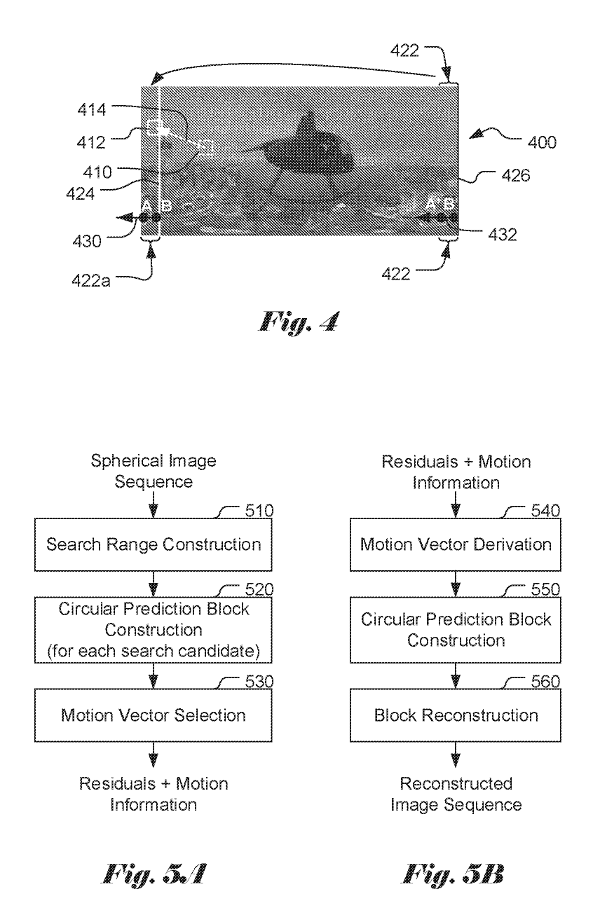

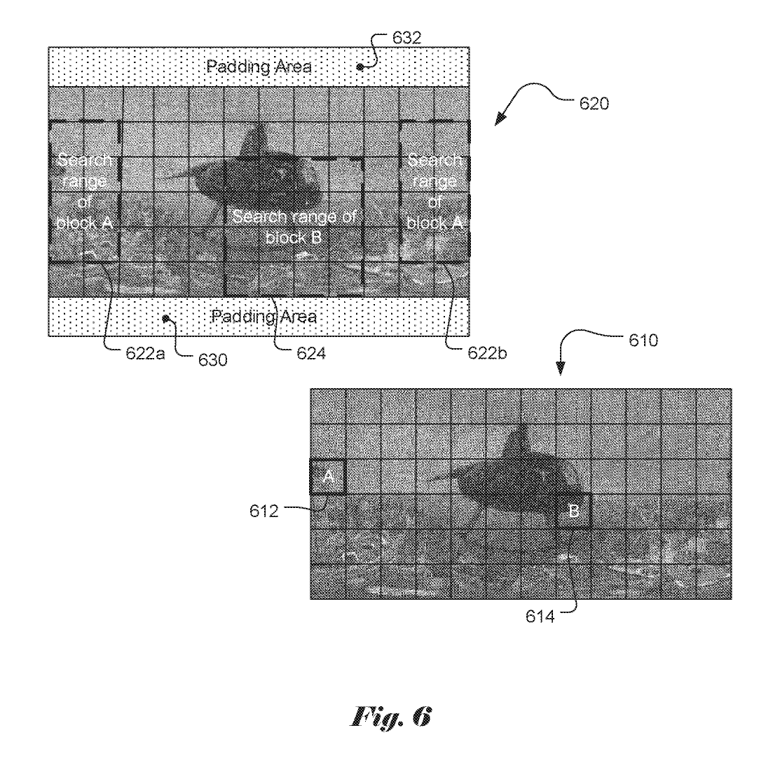

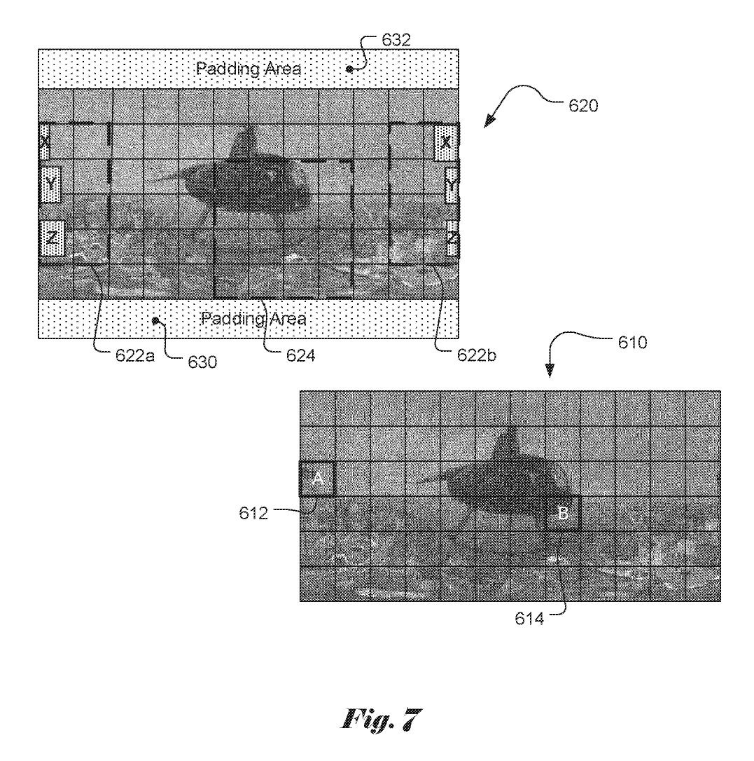

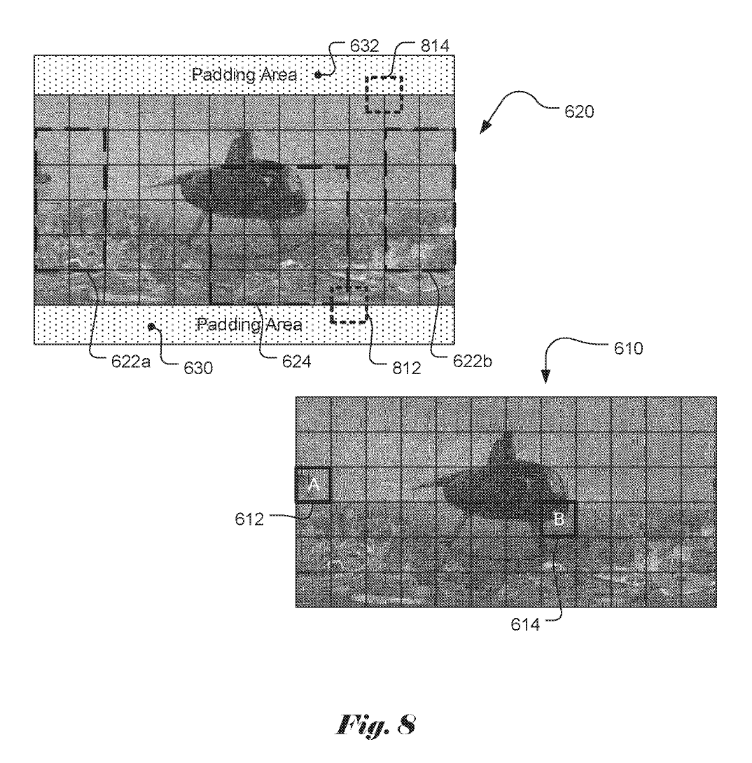

FIG. 6 illustrates an example of circular Inter prediction for a current spherical frame 610. Blocks A and B (612 and 614) are two blocks in the current frame to be coded. Three search windows (622a, 622b and 624) in the reference frame 620 are identified. According to circular Inter prediction, for block A (612), a search window covers an area 622a on the left side of the reference frame and another area 622b on the right side of the reference frame due to the horizontal continuity. For block B (614), a search window covers area 624 near the center of the reference frame. In the vertical direction, the areas (630 and 632) outside the reference frame are filled with padding data such as zero, replicating the boundary values, extending boundary pixels using mirror images of boundary pixel area, or padding with circular repetition of pixels. In FIG. 6, the frame size is V_{w}×Vₕ, where V_{w} corresponds to frame width and Vₕ corresponds to frame height. For each block (e.g. block A or B), the block size is b_{w}×bₕ, where b_{w} corresponds to block width and bₕ corresponds to block height. The search range S is defined as R×R. However, rectangular search area or other search shape known in the field may also be used. The current frame is represented by F=f(x, y) and the reference frame is represented by F=f(x, y). A current block can be represented as:

$${F}_{blk} = f ( x , y ) \vert \begin{matrix}x = {x}_{o} , … , ( {x}_{o} + {b}_{w} - 1 ) \\ y = {y}_{o} , … , ( {y}_{o} + {b}_{h} - 1 )\end{matrix} . \qquad ( 2 )$$

The reference block for motion vector mv=(mvₓ, mv_{y}) can be represented as:

$${\tilde{F}}_{blk} ( mv ) = \tilde{f} ( mod ( x + {mv}_{x} , {V}_{w} ) , y + {mv}_{y} ) \\ \vert \begin{matrix}x = {x}_{o} , … , ( {x}_{o} + {b}_{w} - 1 ) \\ y = {y}_{o} , … , ( {y}_{o} + {b}_{h} - 1 )\end{matrix} . \qquad ( 3 )$$

In the above equation, mod(•,•) is the modulo operation, where the modulo of two operands is defined as follow for integers P and Q:

$$mod ( P , Q ) = P - ⌊ \frac{P}{Q} ⌋ Q .$$

In the above equation, [•] is the floor function. FIG. 7 illustrates an example of three candidate reference blocks (labelled as X, Y and Z in FIG. 7) for the block A (612) in the current frame. As shown in FIG. 7, each of the three candidate reference blocks is crossing the vertical frame boundary. FIG. 8 illustrates another example of reference blocks (812 and 814) that are partially outside the top frame boundary or bottom frame boundary. The pixel samples of the reference blocks (812 and 814) are filled with padding data such as zero, replicating the boundary values, extending boundary pixels using mirror images of boundary pixel area, or padding with circular repetition of pixels. In this case, the padding data are used for these pixels outside the top frame boundary or bottom frame boundary.

The best reference block is selected among the candidate reference blocks within the search window according to a performance criterion, such as minimum rate-distortion cost function calculated according to:

$${mv}^{*} = arg {min}_{mv ∈ S} \{ {D}_{mv} ( {F}_{blk} - {\tilde{F}}_{blk} ) + {λ}_{mv} {R}_{mv} \} . \qquad ( 4 )$$

In the above equation, Dₘᵥ is a distortion measure, Rₘᵥ is the bit rate associated with motion vector mv, and λₘᵥ is Lagrange multiplier. For the minimum distortion based criterion (i.e., disregarding the rate criterion), parameter λₘᵥ is set to 0. After the best MV (i.e., my*) is determined, circular Inter prediction can be applied to the current block according to the best MV to derive the residuals as:

$$e = {F}_{blk} - {\tilde{F}}_{blk} ( {mv}^{*} ) = e ( x , y ) \vert \begin{matrix}x = {x}_{o} \text{∼} {x}_{o} + {b}_{w} - 1 \\ y = {y}_{o} \text{∼} {y}_{o} + {b}_{h} - 1\end{matrix} . \qquad ( 5 )$$

As is known in the field, the residual signal e is subject to coding process such as transform, quantization and entropy coding. The reconstructed residual signal ê is decoded at the decoder side from the video bitstream. Moreover, the reconstructed residual signal ê and the residual signal e are usually different due to coding distortion. At the decoder side, the motion information can be recovered from the bitstream. With the motion vector known, the reference block \tilde{F}_{blk}(mv) can be located. Accordingly, the reconstructed current block \hat{F}_{blk} can be finally obtained according to:

\hat{F}_{blk}=ê+\tilde{F}_{blk}. (6)

Circular Inter Prediction for Cubic Image Sequence

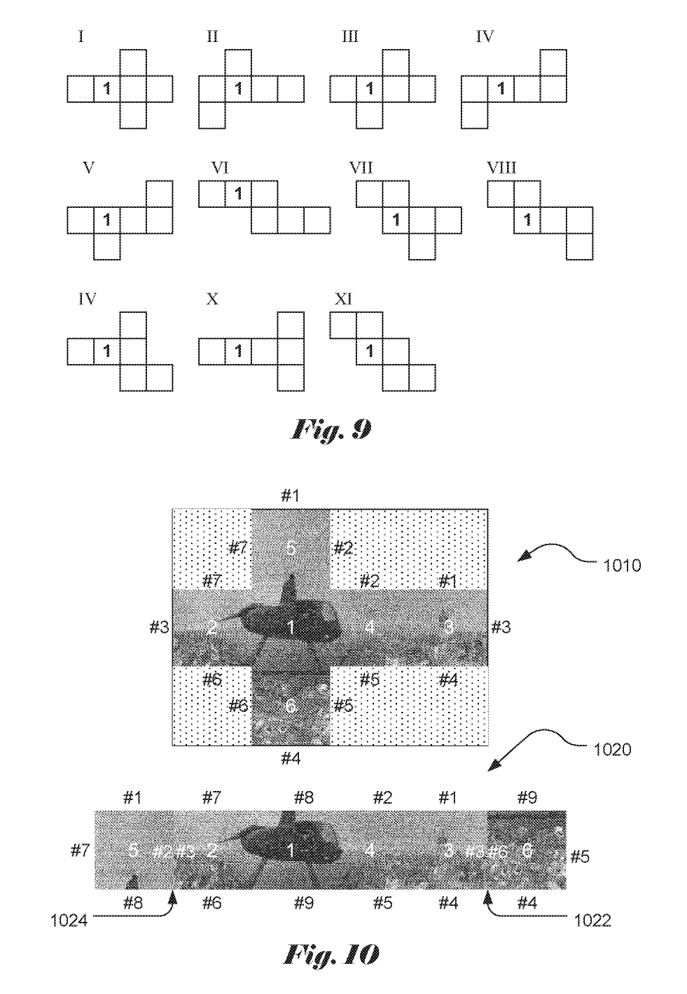

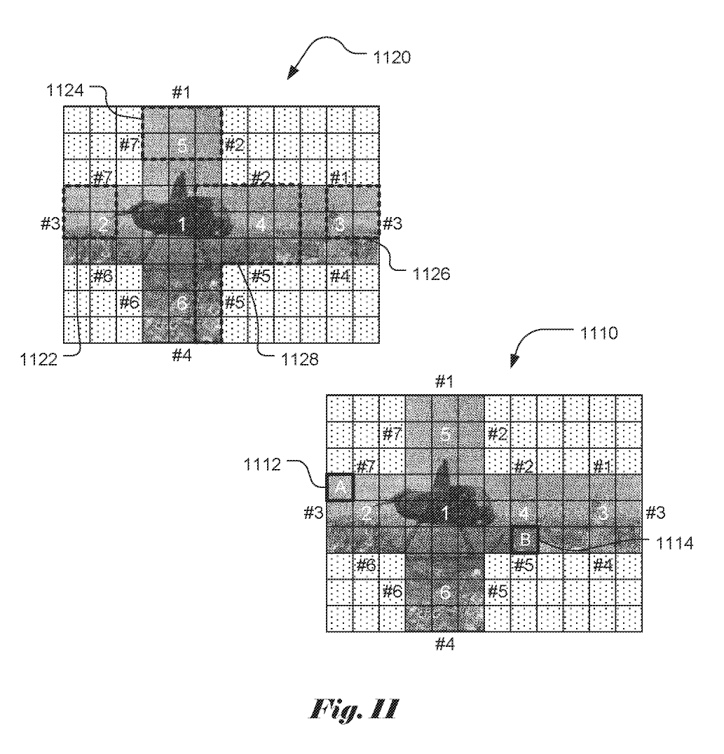

In FIG. 2B and FIG. 2C, two types of cubic frame are illustrated: cubic frame 220 corresponds to a cubic net with blank areas filled with padding data to form a rectangular frame and cubic frame 230 corresponds to six cubic faces assembled without any blank area. For cubic frame corresponding to cubic net with blank areas, the cubic frame can be generated by unfolding the cubic faces into a cubic net consisting of six connected faces. There are 11 distinct cubic nets as shown in FIG. 9, where cube face number 1 is indicated in each cubic net. The cubic frame corresponds to a cubic net with padded blank areas and the cubic frame is formed by fitting the six cubic faces into a smallest rectangular frame that covers all cubic faces. The blank areas can be filled with pre-defined pixel data such as zero (black), 0, 2^{BitDepth/2} (gray), or 2^{BitDepth}−1 (white), where the BitDepth is the number of bits used to indicate each color component of a pixel sample. On the other hand, the six cubic faces are rearranged into a rectangular frame without any blank area. The assembled cubic frame without any blank area for cubic frame 230 represents an assembled 1×6 cubic-face frame. Furthermore, there are other possible types of assembled cubic frames, such as 2×3, 3×2 and 6×1 assembled cubic-face images. These assembled forms for cubic faces are also included in this invention.

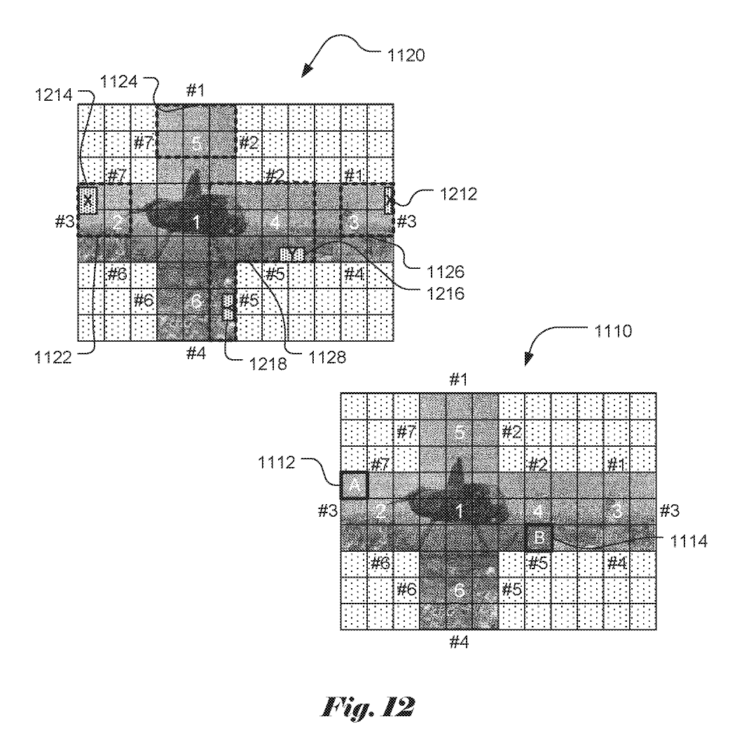

These six cube faces are interconnected in a certain fashion as shown in FIG. 2A. For example, the right side of cubic face 5 is connected to the top side of cubic face 4; and the right side of cubic face 3 is connected to the left side of cubic face 2. Accordingly, the circular edge labeling for the six cubic faces is disclosed in this invention to indicate circular edges at cubic face boundaries (or edges) according to the cubic face continuity. FIG. 10 illustrates examples of the circular edge labeling for the six cubic faces of a cubic frame corresponding to a cubic net with blank areas filled with padding data (1010) and an assembled 1×6 cubic-face frame (1020). Within the assembled 1×6 cubic-face cubic frame, there are two discontinuous cubic-face boundaries (1022 and 1024). For cubic frames, the circular edge labelling is only needed for any non-connected or discontinuous cubic-face image edge. For connected continuous cubic-face edges (e.g., between bottom edge of cubic face 5 and top edge of cubic face 1 and between the right edge of cubic face 4 and the left edge of cubic face 3), there is no need for circular edge labeling.

With the circular edges labelled, the circular search area can be easily identified according to edges labelled with a same label number. For example, the top edge (#1) of cubic face 5 is connected to the top edge (#1) of cubic face 3. Therefore, access to the reference pixel above the top edge (#1) of cubic face 5 will go into cubic face 3 from its top edge (#1). Accordingly, for circular Inter prediction, when the reference area is outside or crossing a circular edge, the reference block can be located by accessing the reference pixels circularly according to the circular edge labels. Therefore, the reference block for a current block may come from other cubic faces or as a combination of two different cubic faces. Furthermore, for circular edge with the same label, if one edge is in the horizontal direction and the other is in the vertical direction, the reference pixels associated with two different edges need to be rotated to form a complete reference block. For example, reference pixels near the right edge (#5) of cubic face 6 have to be rotated counter-clockwise by 90 degrees before they can be combined with reference pixels near the bottom edge (#5) of cubic face 4. On the other hand, if both edges with the same edge label correspond to top edges or bottom edges of two corresponding cubic-face images, the reference pixels associated with two different edges need to be rotated to form a complete reference block. For example, reference pixels near the top edge (#1) of cubic face 5 have to be rotated 180 degrees before they can be combined with reference pixels near the top edge (#1) of cubic face 3.

The cost function associated with each possible motion vector can be evaluated and then a best motion vector that has the minimum cost can be obtained. The residuals for the current frame are generated from the differences between the current block and the selected reference block. The residuals are then coded and signaled in the video bitstream. As before, the motion information related to the selected motion vector may need to be signaled in the video bitstream so that the motion information can be recovered at the decoder side. As mentioned before, the motion information can be predictively coded using a motion vector predictor to reduce coding bits. At the decoder side, the reference block can be identified and accessed according to the received motion information. Again, when reference area is outside or crossing a circular edge, reference pixels can be circularly accessed according to circular edge labels. The current block can be reconstructed from the residuals derived from the received video bitstream and the reference block.

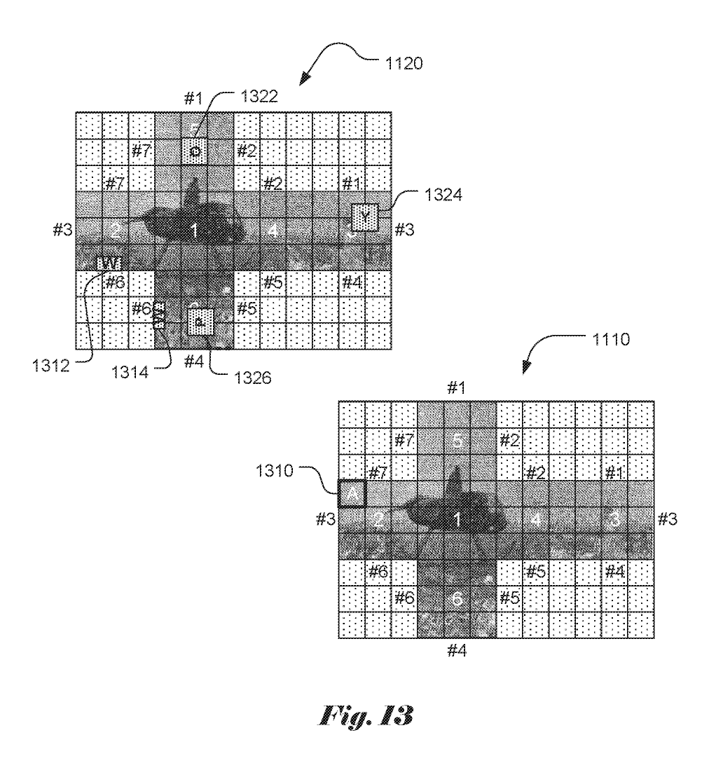

FIG. 11 illustrates an example of circular Inter prediction for cubic frame corresponding to a cubic net with blank areas filled with padding data. Blocks A and B (1112 and 1114) are two blocks in the current frame to be processed. The search window identified for block A includes reference areas 1122, 1124 and 1126. Area 1122 contains the co-located block of block A. However, the search area 1122 is very limited. When a larger search area is desired, the circular edges of the reference area 1122 are identified (i.e., #3 on the left side and #7 on the top side). The circular edge extending from edge #7 of cubic face 2 goes into the edge #7 of cubic face 5. Accordingly, reference area 1124 is identified. The circular edge extending from edge #3 of cubic face 2 goes into the edge #3 of cubic face 3. Accordingly, reference area 1126 is identified.

FIG. 12 illustrates an example of a reference block X (1212 and 1214) for block A in the current frame. The reference block X crosses the circular edge #3 of cubic face 2 to flow into the cubic face 3 from its circular edge #3. Therefore, part of reference block X (1214) is located in cubic face 2 and part of reference block X (1212) is located in cubic face 3. FIG. 12 also illustrates an example of a reference block Y (1216 and 1218) for block B in the current frame. The reference block Y crosses the circular edge #5 of cubic face 4 to flow into the cubic face 6 from its circular edge #5. Therefore, part of reference block Y (1216) is located in cubic face 4 and part of reference block Y (1218) is located in cubic face 6. The contents at the bottom end (i.e., circular edge #5) of cubic face 4 are continuous with the contents at the right end (i.e., circular edge #5) of cubic face 6. In other words, if cubic face 6 is rotated counter-clockwise by 90 degrees, the circular edge #5 from cubic faces 4 and 6 can be butted and contents are continuous across the butted edge. The orientation of letter “Y” for area 1218 is rotated to indicate that the reference pixels in area 1218 need to be rotated to the same orientation as area 1216 to form a complete reference block for the current block B.

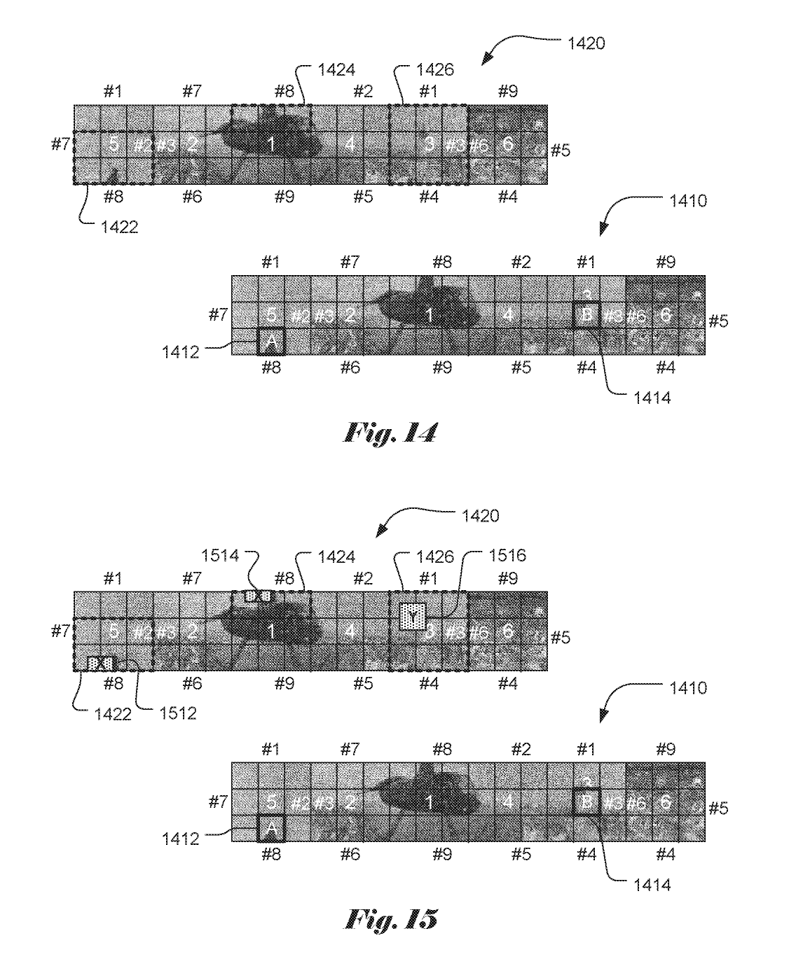

FIG. 13 illustrates another example of accessing reference pixels circularly according to circular edge labeling for cubic frame corresponding to a cubic net with padded blank areas. In this example, the search window is enlarged to cover larger areas. Four candidate reference blocks (W, Q, Y and P) are shown in different areas. For reference block W, the block crosses circular edge #6 and the reference pixels consist of area 1312 from cubic face 2 and area 1314 from cubic face 6. Since cubic faces 2 and 6 are connected at circular edge #6, the area 1314 has to be rotated clockwise by 90 degrees and joined with area 1312 to form a complete reference block W. For reference block Q, the contents at the top end (i.e., circular edge #5) of cubic face 2 are continuous with the contents at the left end (i.e., circular edge #7) of cubic face 5. Therefore, the reference block Q (1322) needs to be rotated counter-clockwise by 90 degrees (or rotated clockwise by 270 degrees) before ME/MC. Similarly, for reference block P (1326), the contents at the bottom end (i.e., circular edge #6) of cubic face 2 are continuous with the contents at the left end (i.e., circular edge #6) of cubic face 6. Therefore, the reference block P needs to be rotated clockwise by 90 degrees before ME/MC. The reference block Y can be directly used for Inter prediction without any rotation.

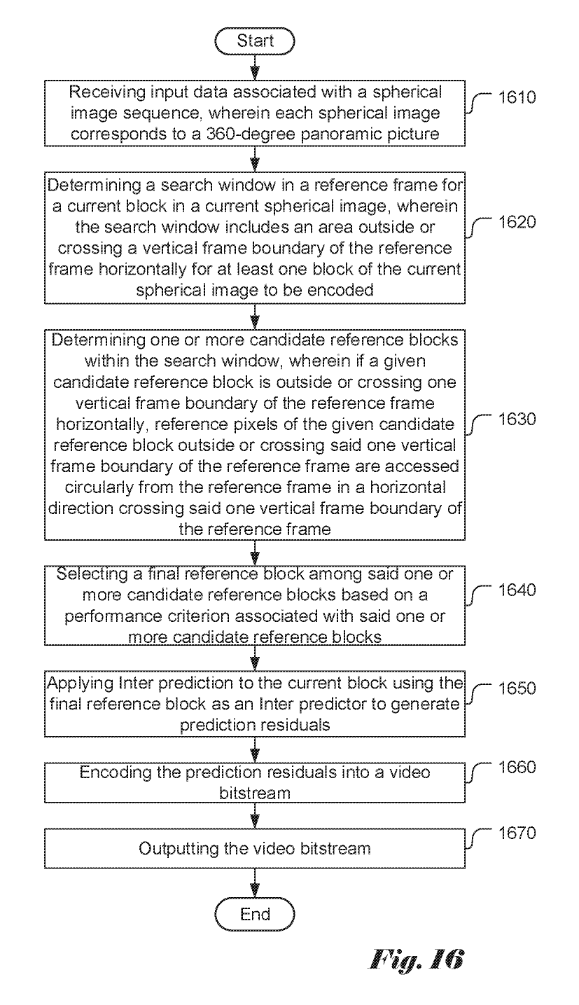

FIG. 14 illustrates an example of circular Inter prediction for cubic frame corresponding to an assembled cubic frame without blank area. Blocks A and B (1412 and 1414) are two blocks in the current frame 1410 to be processed. The search window identified for block A includes reference areas 1422, and 1424 in the reference frame 1420. Area 1422 contains the co-located block of block A. However, the search area 1422 is very limited. When a larger search area is desired, the circular edge of the reference area 1422 is identified (i.e., #8 on the bottom side). The circular edge extending from edge #8 of cubic face 5 goes into the edge #8 of cubic face 1. Accordingly, reference area 1424 is identified. The search window identified for block B includes reference area 1426 in the reference frame 1420.

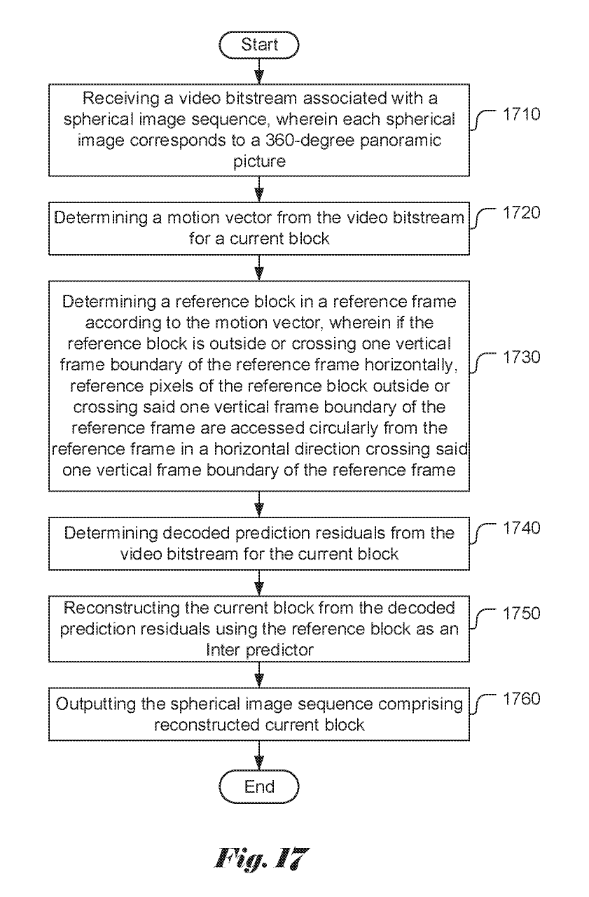

FIG. 15 illustrates an example of accessing reference pixels circularly according to circular edge labeling for cubic frame corresponding to an assembled cubic frame without padding blank area. In this example, the search window is enlarged to cover larger areas. Two candidate reference blocks (X and Y) are shown in different areas for blocks A and B to be processed respectively. For reference block X, the block crosses circular edge #8 and the reference pixels consist of area 1512 from cubic face 5 and area 1514 from cubic face 1. Since cubic faces 5 and 1 are connected at circular edge #8, the areas 1512 and 1514 can be joined (without any rotation) to form a complete reference block X. For block B, reference block Y 1516 can be directly used for Inter prediction.

In FIG. 12, for each block (e.g. block A or B), the block size is b_{w}×bₕ, where b_{w} corresponds to block width and bₕ corresponds to block height. The search range S is defined as R×R. The current frame is represented by F=f(x, y) and the reference frame is represented by F=f(x, y). Accordingly, a current block can be represented as:

$${F}_{blk} = f ( x , y ) \vert \begin{matrix}x = {x}_{o} , … , ( {x}_{o} + {b}_{w} - 1 ) \\ y = {y}_{o} , … , ( {y}_{o} + {b}_{h} - 1 )\end{matrix} . \qquad ( 7 )$$

The reference block for motion vector mv=(mvₓ, mv_{y}) can be represented as:

$${\tilde{F}}_{blk} ( mv ) = \tilde{f} ( circ ( x + {mv}_{x} ) , circ ( y + {mv}_{y} ) ) \\ \vert \begin{matrix}x = {x}_{o} , … , ( {x}_{o} + {b}_{w} - 1 ) \\ y = {y}_{o} , … , ( {y}_{o} + {b}_{h} - 1 )\end{matrix} . \qquad ( 8 )$$

In the above equation, circ(•) represents circular indexing to access reference pixels across a circular edge and to assemble the reference block with rotation if necessary. With the reference block identified according to circular access, the remaining Inter prediction process is similar to the approach for circular Inter prediction for spherical image sequences. For example, the same cost function in eq. (4) can be used to select a best motion vector mv*.

After the best MV (i.e., mv*) is determined, circular Inter prediction can be applied to the current block according to the best MV to derive the residuals e=F_{blk}−\tilde{F}_{blk}(mv*). As is known in the field, the residual signal e is subject to coding process such as transform, quantization and entropy coding. The reconstructed residual signal ê is generated at the decoder side from the video bitstream. At the decoder side, the motion information can be recovered from the video bitstream. With the motion vector known, the reference block \tilde{F}_{blk}(mv) can be located by accessing reference pixels circularly according to circular edge labelling. Accordingly, the reconstructed current block \hat{F}_{blk} can be derived according to \hat{F}_{blk}=ê+\tilde{F}_{blk}.

In the above, circular Inter prediction techniques are disclosed to process spherical image sequences and cubic image sequences. For spherical frames, the characteristics of horizontal continuity of the spherical images are taken into consideration during circular Inter prediction process. Accordingly, these reference pixels, used to be unavailable for conventional Inter prediction when the reference pixels is outside the frame boundary in the horizontal direction, become available according to the circular Inter prediction. For the cubic frames, there are two types of cubic frames corresponding to a cubic net with the blank areas filled with padding data and an assembled rectangular frame without any blank area. According to the circular Inter prediction techniques, circular edges are identified. Each circular edge corresponds to one edge of the cube, where contents of two connecting faces are continuous from one face to the other. When the reference pixels of a reference block cross a circular edge, the reference pixels crossing the circular edge can be accessed by crossing the circular edge into the connecting cubic face. After reference blocks are identified according to circular edges, a best motion vector can be determined by using a cost function. The reference block corresponding to the best motion vector is used as a predictor for the current block to generate residuals for the current block. The residuals may be subsequently compressed using compression techniques, such as transform, quantization and entropy coding. At the decoder side, an inverse processing can be applied to recover the coded residuals. The decoder can use the circular Inter prediction disclosed above to reconstruct a current block.

FIG. 16 illustrates an exemplary flowchart for a video encoder incorporating an embodiment of the present invention, where circular Inter prediction is applied to a spherical image sequence. According to this method, input data associated with a spherical image sequence are received in step 1610, where each spherical image corresponds to a 360-degree panoramic picture. A search window in a reference frame for a current block in a current spherical image is determined in step 1620, where the search window includes an area outside or crossing a vertical frame boundary of the reference frame for at least one block of the current spherical image to be encoded. To take advantage of continuity in the horizontal direction, when the search area goes beyond the left or right frame boundary, the search window is wrapped around to the other edge of the frame boundary as disclosed above. One or more candidate reference blocks within the search window are determined in step 1630. If a given candidate reference block is outside or crossing one vertical frame boundary of the reference frame, reference pixels of the given candidate reference block outside or crossing said one vertical frame boundary of the reference frame are accessed circularly from the reference frame in a horizontal direction crossing said one vertical frame boundary of the reference frame. A final reference block is selected among said one or more candidate reference blocks based on a performance criterion associated with said one or more candidate reference blocks in step 1640. Inter prediction is then applied to the current block using the final reference block as an Inter predictor to generate prediction residuals in step 1650. The prediction residuals are encoded into a video bitstream in step 1660 and the video bitstream is outputted in step 1670.

FIG. 17 illustrates an exemplary flowchart for a video decoder incorporating an embodiment of the present invention, where circular Inter prediction is applied to a spherical image sequence. A video bitstream associated with a spherical image sequence is received in step 1710, where each spherical image corresponds to a 360-degree panoramic picture. A motion vector is derived from the video bitstream for a current block in step 1720. A reference block in a reference frame is determined according to the motion vector in step 1730. If the reference block is outside or crossing one vertical frame boundary of the reference frame, reference pixels of the reference block outside or crossing said one vertical frame boundary of the reference frame are accessed circularly from the reference frame in a horizontal direction crossing said one vertical frame boundary of the reference frame. The decoded prediction residuals are derived from the video bitstream for the current block in step 1740. The current block is reconstructed from the decoded prediction residuals using the reference block as an Inter predictor in step 1750. The spherical image sequence comprising reconstructed current block is then outputted in step 1760.

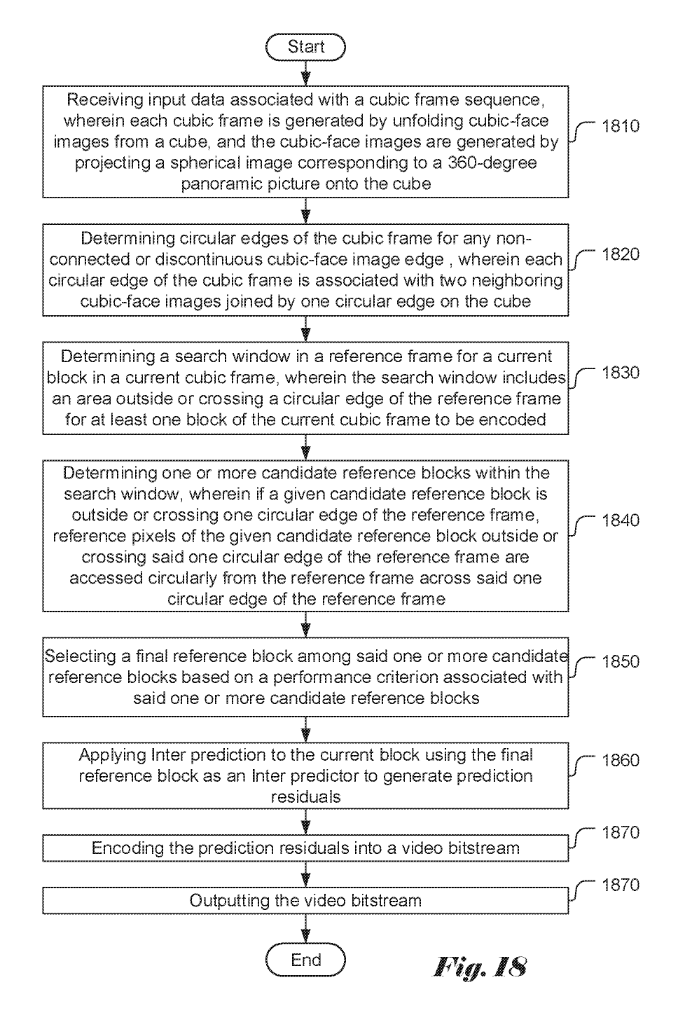

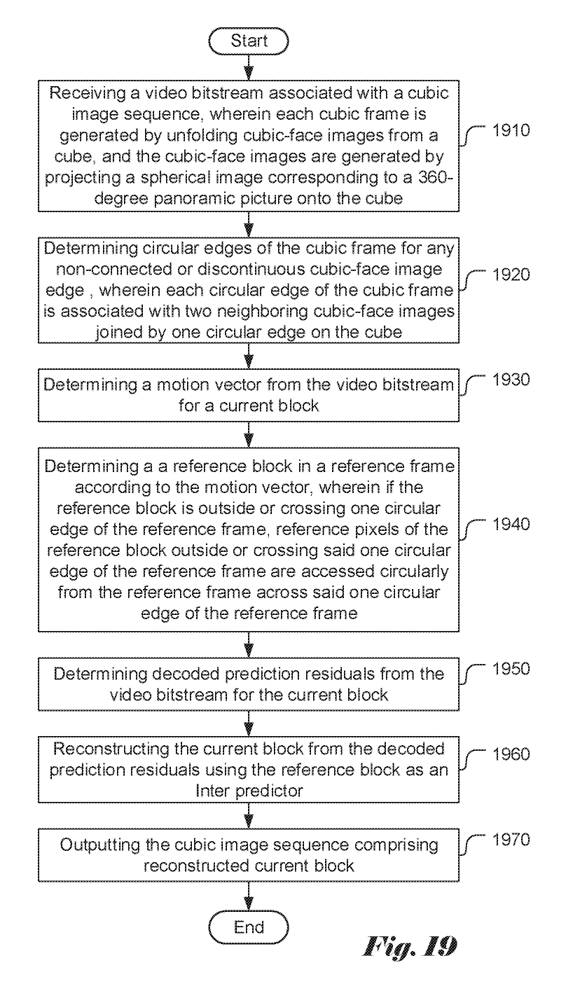

FIG. 18 illustrates an exemplary flowchart for a video encoder incorporating an embodiment of the present invention, where circular Inter prediction is applied to a cubic image sequence. According to this method, input data associated with a cubic image sequence are received in step 1810, where each cubic frame is generated by unfolding six cubic faces from a cube, and the six cubic faces are generated by projecting a spherical image corresponding to a 360-degree panoramic picture onto the cube. Circular edges of the cubic frame are determined for any non-connected or discontinuous cubic-face image edge in step 1820, where each circular edge of the cubic frame is associated with two neighboring cubic-face images joined by one circular edge on the cube. A search window in a reference frame is determined for a current block in a current cubic frame in step 1830, where the search window includes an area outside or crossing a circular edge of the reference frame for at least one block of the current cubic frame to be encoded. One or more candidate reference blocks within the search window are determined in step 1840. If a given candidate reference block is outside or crossing one circular edge of the reference frame with respect to a co-located block of the current block, reference pixels of the given candidate reference block outside or crossing said one circular edge of the reference frame are accessed circularly from the reference frame across said one circular edge of the reference frame. A final reference block is selected among said one or more candidate reference blocks based on a performance criterion associated with said one or more candidate reference blocks in step 1850. Inter prediction is then applied to the current block using the final reference block as an Inter predictor to generate prediction residuals in step 1860. The prediction residuals are encoded into a video bitstream in step 1870 and the video bitstream is outputted in step 1880.

FIG. 19 illustrates an exemplary flowchart for a video decoder incorporating an embodiment of the present invention, where circular Inter prediction is applied to a cubic image sequence. According to this method, a video bitstream associated with a cubic image sequence is received in step 1910, where each cubic frame is generated by unfolding six cubic faces from a cube, and the six cubic faces are generated by projecting a spherical image corresponding to a 360-degree panoramic picture onto the cube. Circular edges of the cubic frame for any non-connected or discontinuous cubic-face image edge are determined in step 1920, where each circular edge of the cubic frame is associated with two neighboring cubic-face images joined by one circular edge on the cube. A motion vector is derived from the video bitstream for a current block in step 1930. Then, in step 1940, a reference block in a reference frame is determined according to the motion vector 19. If the reference block is outside or crossing one circular edge of the reference frame with respect to a co-located block of the current block, reference pixels of the reference block outside or crossing said one circular edge of the reference frame are accessed circularly from the reference frame across said one circular edge of the reference frame. The decoded prediction residuals are derived from the video bitstream for the current block in step 1950. The current block is reconstructed from the decoded prediction residuals using the reference block as an Inter predictor in step 1960. The cubic image sequence comprising reconstructed current block is then outputted in step 1970.

The above flowcharts may correspond to software program codes to be executed on a computer, a mobile device, a digital signal processor or a programmable device for the disclosed invention. The program codes may be written in various programming languages such as C++. The flowchart may also correspond to hardware based implementation, where one or more electronic circuits (e.g. ASIC (application specific integrated circuits) and FPGA (field programmable gate array)) or processors (e.g. DSP (digital signal processor)).

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. An apparatus for video encoding applied to a spherical image sequence, the apparatus comprising one or more electronics or processors arranged to:
receive input data associated with a spherical image sequence, wherein each spherical image corresponds to a 360-degree panoramic picture;
determine a search window in a reference frame for a current block in a current spherical image, wherein the search window includes an area outside or crossing a vertical frame boundary of the reference frame for at least one block of the current spherical image to be encoded;
determine one or more candidate reference blocks within the search window, wherein if a given candidate reference block is outside or crossing one vertical frame boundary of the reference frame, reference pixels of the given candidate reference block outside or crossing said one vertical frame boundary of the reference frame are accessed circularly from the reference frame in a horizontal direction crossing said one vertical frame boundary of the reference frame;
select a final reference block among said one or more candidate reference blocks based on a performance criterion associated with said one or more candidate reference blocks;
apply Inter prediction to the current block using the final reference block as an Inter predictor to generate prediction residuals;
encode the prediction residuals into a video bitstream; and
output the video bitstream.

2. The apparatus of claim 1, wherein if the given candidate reference block is outside or crossing one horizontal frame boundary of the reference frame, the reference pixels of the given candidate reference block outside said one horizontal frame boundary of the reference frame are padded according to a padding process.

3. The apparatus of claim 1, wherein if the given candidate reference block is outside or crossing one vertical frame boundary of the reference frame, the reference pixels of the given candidate reference block outside or crossing said one vertical frame boundary of the reference frame are accessed circularly from the reference frame in a horizontal direction by using a modulo operation on horizontal-axis (x-axis) of the reference pixels of the given candidate reference block.

4. An apparatus for video decoding applied to a spherical image sequence, the apparatus comprising one or more electronics or processors arranged to:
receive a video bitstream associated with a spherical image sequence, wherein each spherical image corresponds to a 360-degree panoramic picture;
derive a motion vector from the video bitstream for a current block;
determine a reference block in a reference frame according to the motion vector, wherein if the reference block is outside or crossing one vertical frame boundary of the reference frame, reference pixels of the reference block outside or crossing said one vertical frame boundary of the reference frame are accessed circularly from the reference frame in a horizontal direction crossing said one vertical frame boundary of the reference frame;
derive decoded prediction residuals from the video bitstream for the current block;
reconstruct the current block from the decoded prediction residuals using the reference block as an Inter predictor; and
output the spherical image sequence comprising reconstructed current block.

5. The apparatus of claim 4, wherein if the reference block is outside or crossing one horizontal frame boundary of the reference frame, the reference pixels of the reference block outside said one horizontal frame boundary of the reference frame are padded according to a padding process.

6. The apparatus of claim 4, wherein if the reference block is outside or crossing one vertical frame boundary of the reference frame, the reference pixels of the reference block outside or crossing said one vertical frame boundary of the reference frame are accessed circularly from the reference frame in a horizontal direction by using a modulo operation on horizontal-axis (x-axis) of the reference pixels of the reference block.

7. An apparatus for video encoding applied to a cubic image sequence in a video encoder, the apparatus comprising one or more electronics or processors arranged to:
receive input data associated with a cubic image sequence, wherein each cubic frame, one image of the cubic image sequence, is generated by unfolding six cubic faces from a cube, and the six cubic faces are generated by projecting a spherical image corresponding to a 360-degree panoramic picture onto the cube;
determine circular edges of the cubic frame for any non-connected or discontinuous cubic face edge, wherein each circular edge of the cubic frame is associated with two neighboring cubic faces joined by one circular edge on the cube;
determine a search window in a reference frame for a current block in a current cubic frame, wherein the search window includes an area outside or crossing a circular edge of the reference frame for at least one block of the current cubic frame to be encoded;
determine one or more candidate reference blocks within the search window, wherein if a given candidate reference block is outside or crossing one circular edge of the reference frame with respect to a co-located block of the current block, reference pixels of the given candidate reference block outside or crossing said one circular edge of the reference frame are accessed circularly from the reference frame across said one circular edge of the reference frame;
select a final reference block among said one or more candidate reference blocks based on a performance criterion associated with said one or more candidate reference blocks;
apply Inter prediction to the current block using the final reference block as an Inter predictor to generate prediction residuals;
encode the prediction residuals into a video bitstream; and
output the video bitstream.

8. The apparatus of claim 7, wherein each cubic frame corresponds to one cubic net with blank areas filled with padding data to form a rectangular frame.

9. The apparatus of claim 7, wherein each cubic frame corresponds to one assembled frame without any padding area.

10. The apparatus of claim 7, wherein if the given candidate reference block is outside or crossing one circular edge of the reference frame with respect to a co-located block of the current block, the reference pixels of the given candidate reference block outside or crossing said one circular edge of the reference frame are accessed circularly from the reference frame by applying a circular operation on horizontal-axis (x-axis) and vertical-axis (y-axis) of the reference pixels of the given candidate reference block, and wherein the circular operation takes into account of continuity across the circular edges.

11. The apparatus of claim 10, wherein the circular operation causes the reference pixels of the given candidate reference block outside or crossing said one circular edge of the reference frame rotated by a rotation angle determined according to an angle between said one circular edge of the reference frame and a corresponding circular edge.

12. The apparatus of claim 11, the rotation angle includes 0, 90, 180 and 270 degrees.

13. An apparatus for video decoding applied to a cubic image sequence in a video decoder, the apparatus comprising one or more electronics or processors arranged to:
receive a video bitstream associated with a cubic image sequence, wherein each cubic frame, one image of the cubic image sequence, is generated by unfolding six cubic faces from a cube, and the six cubic faces are generated by projecting a spherical image corresponding to a 360-degree panoramic picture onto the cube;
determine circular edges of the cubic frame for any non-connected or discontinuous cubic face edge, wherein each circular edge of the cubic frame is associated with two neighboring cubic faces joined by one circular edge on the cube;
derive a motion vector from the video bitstream for a current block;
determine a reference block in a reference frame according to the motion vector, wherein if the reference block is outside or crossing one circular edge of the reference frame with respect to a co-located block of the current block, reference pixels of the reference block outside or crossing said one circular edge of the reference frame are accessed circularly from the reference frame across said one circular edge of the reference frame;
derive decoded prediction residuals from the video bitstream for the current block;
reconstruct the current block from the decoded prediction residuals using the reference block as an Inter predictor; and
output the cubic image sequence comprising reconstructed current block.

14. The apparatus of claim 13, wherein each cubic frame corresponds to one cubic net with blank areas filled with padding data to form a rectangular frame.

15. The apparatus of claim 13, wherein each cubic frame corresponds to one assembled frame without any padding area.

16. The apparatus of claim 13, wherein if the reference block is outside or crossing one circular edge of the reference frame with respect to a collocated block of the current block, the reference pixels of the reference block outside or crossing said one circular edge of the reference frame are accessed circularly from the reference frame by applying a circular operation on horizontal-axis (x-axis) and vertical-axis (y-axis) of the reference pixels of the reference block, and wherein the circular operation takes into account of continuity across the circular edges.

17. The apparatus of claim 16, wherein the circular operation causes the reference pixels of a given candidate reference block outside or crossing said one circular edge of the reference frame rotated by a rotation angle determined according to an angle between said one circular edge of the reference frame and a corresponding circular edge.

18. The apparatus of claim 17, the rotation angle includes 0, 90, 180 and 270 degrees.
